(19) United States
(12) Patent Application Publication
(10) Pub. No.: US 2004/0103215 A1
(43) Pub. Date: May 27, 2004

(54) Selective compression of web-based data transmissions

(75) Inventors: Theodore R. Ernst, Sugar Land, TX (US); Greg Dugi, Sugar Land, TX (US)

Correspondence Address: WONG, CABELLO, LUTSCH, RUTHERFORD & BRUCCULERI,, P.C., 20333 SH 249, SUITE 600, HOUSTON, TX, 77070, US

(73) Assignee: BMC Software, Inc., Houston, TX

(21) Appl. No.: 10/305,220

(22) Filed: Nov. 26, 2002

(51) Int. Cl. G06F 15/16

(52) U.S. Cl. 709/247; 709/203; 709/218

(57) ABSTRACT

Server-side techniques to selectively compress data for transmission to a client application are described. Characteristics such as the effective transmission rate between the server computer system and a client computer system requesting the data are used to determine if data compression is beneficial. In addition, characteristics of the server computer system such as its processor utilization, for example, may be used to determine if data compression is beneficial. Selective compression in accordance with these techniques provide improved user-responsiveness without the need to install, configure or maintain a client-side application. Accordingly, selective compression in accordance with the invention is particularly beneficial in large, distributed networks in which one or a few “server” computers provide data access service to a large number of “client” computer systems.

### BACKGROUND

The invention relates generally to data compression and, more particularly but not by way of limitation, to the selective compression of data based on user-specified controls in an web-based operating environment.

Today, a significant portion of many businesses interact with the public is by way of the Internet in the form of World Wide Web browsing. In addition, most businesses have web servers with content targeted at their own employees, often referred to as “intranets.” The same is true of educational institutions and government agencies. The popularity and growth of browsing the Internet and intranets have led to performance issues and user frustration with timeouts or long wait times to receive the information requested via their browsers.

Virtually all Internet and intranet traffic is carried via the Transport Control Protocol/Internet Protocol (TCP/IP). TCP/IP performance is generally excellent over lightly loaded networks (30% or lower utilization). On heavily loaded networks running at higher utilization levels (50% and above), however, serious performance bottlenecks can occur. In high utilization environments network devices such as bridges, switches and routers (which generally have very limited buffering and queuing capabilities) respond to congestion by discarding those frames or packets they cannot process. In response, the host systems that initiated transmission of the discarded frames or packets retransmit the lost data, thus adding to the congestion. It is not all that unusual to see a TCP/IP network running at 80% to 90% utilization while only experiencing 10% to 15% throughput. As a result, users experience slow response time, application faults and server disconnects. This is particularly the case for web browsers using the HyperText Transfer Protocol (HTTP). Thus, it is no surprise that administrators of heavily utilized networks have been implementing various approaches to reduce traffic and improve the performance of communications running over them.

One approach to addressing network congestion has been the development of hardware/firmware devices such as load balancers and traffic shapers—devices that attempt to regulate network loads and traffic patterns. Another approach to addressing network congestion has been to provide users with increased bandwidth in the form of faster backbones. In the intranet environment, this has meant the deployment of high-speed corporate backbones. In the Internet environment, this has meant the deployment of larger bandwidth public accessible backbones and digital subscriber lines (DSL) and cable modems for consumer use. Yet another approach to addressing network congestion is to compress data before it is transmitted. For example, a host computer system's web server may be configured to compress all of the data it transmits via a given protocol (e.g., the HTTP protocol) or to an identified destination. Web server applications that support data compression in this way include the Internet Information Services (IIS) from the Microsoft corporation, the iPlanet web server supported by Sun Microsystems and the Apache web server available through the open-source software project and supported by the Apache Software Foundation. Most currently available web servers support “gzip” compression (a compression routine freely available through the GNU Project), while all known web browsers currently available support gzip decompression.

There are at least two drawbacks to the compression techniques available in current web servers. First, the act of compressing data is processor-intensive. Second, compressing data often does not result in a significant improvement in transmission speed because the data object simply does not compress or the amount of compression achieved does not justify the computational overhead incurred by the act of compressing. For example, compressing image files such as Graphic Image Format (GIF) or Joint Photographic Experts Group (JPEG) files does not generally result in any significant reduction in the image files' size—thus, the time spent “compressing” these types of files is wasted in the sense of improved transmission time to a web browser end-user.

One prior art technique that recognized the drawback to an “all or nothing” compression approach is the PATROL IP/Optimizer product from BMC Software, Inc. Referring to FIG. 1, PATROL IP/Optimizer utilized a two-sided approach wherein server application 100 running on server computer system 105, communicated via link 110 with client application 115 running on client computer system 120. All communications of a specified type (e.g., communications related to a specified application or IP traffic) between server 105 and client 120 passed through applications 100 and 115 and could, therefore, be selectively compressed based on user specified criteria. For example, all data except specified file types (e.g., image files or files stored in compressed format) could be compressed. Another feature of IP/Optimizer's two-sided approach was that both server application 100 and client application 115 could time-stamp the packets/frames they transmitted via link 110. This, in turn, allowed IP/Optimizer to determine the speed of link 110. If it was determined during data packet/frame transmission between server 105 and client 120 that compression was not saving transmission time, the remainder of the data packets/frames that would have been compressed (in accordance with user specified criteria) were sent uncompressed. While a two-sided approach to selective data compression allows a large degree of control by the user, it does not scale to large networks such as the Internet (or even large corporate intranets) because it is not always practical to load client application 115 on each new client computer system. This is particularly true in the Internet environment where the “user” is a consumer.

Another prior art technique that has been used to selectively compress data between two computer systems employs a proxy server. Referring to FIG. 2, in this approach proxy server computer system 200 is inserted between web server computer system 205 and client computer system 210 in a manner that is transparent to a user of client 210. That is, a user directs their communication to server 205 without knowledge that proxy server 200 is in place. This approach allows proxy server 200 to selectively compress data flowing from server 205 to client 210 in a manner similar to that of a system in accordance with FIG. 1. One drawback to this approach is that the purchase, installation and maintenance of proxy server 200 represents a significant cost. Another drawback to a system in accordance with FIG. 1 is that proxy server 200 represents a single point failure. That is, if proxy server 200 fails (due to hardware and/or software malfunctions) server 205 goes off-line with respect to client 210.

Thus, it would be beneficial to provide a means to selectively compress data based on user-specified constraints in a manner that optimizes transmission of the data between two computer systems and which does not rely on client-side software and/or proxy server hardware.

### SUMMARY

In one embodiment the invention provides a method to selectively compress data transmitted between server and client computer systems. The method includes receiving a request for data from a web-based application executing on the client computer, determining a plurality of characteristics associated with the client, passing the request to an application executing on the server, receiving a response from the server (the response having a data component), selectively compressing the data component based on a match between at least one of the client characteristics and at least one attribute associated with the data component, and transmitting the selectively compressed data component to the client. The method may be stored in any media that is readable and executable by a computer system.

### BRIEF DESCRIPTION OF THE DRAWINGS

FIG. 1 shows a block diagram of one prior art system used to selectively compress data between server and client computer systems.

FIG. 2 shows a block diagram of another prior art system that can be used to selectively compress data between server and client computer systems.

FIG. 3 shows a block diagram of a computer system in accordance with one embodiment of the invention.

FIG. 4 shows, in flowchart form, a selective compression routine in accordance with one embodiment of the invention.

FIG. 5 shows, in time sequence, how a selective compression routine captures client information during HyperText Transport Protocol (HTTP) connection set-up in one embodiment of the invention.

FIG. 6 shows, in flowchart form, how a selective compression routine in accordance with one embodiment of the invention determines if the data it receives is eligible for compression.

FIG. 7 shows, in block diagram form, data storage areas used and maintained by a selective compression routine in accordance with one embodiment of the invention.

FIG. 8 shows, in flowchart form, how a selective compression routine in accordance with one embodiment of the invention determines if the data it receives has previously been compressed and, if so, if the compressed data is available for transmission.

FIG. 9 shows, in flowchart form, the acts of block 440 in FIG. 4 in accordance with one embodiment of the invention.

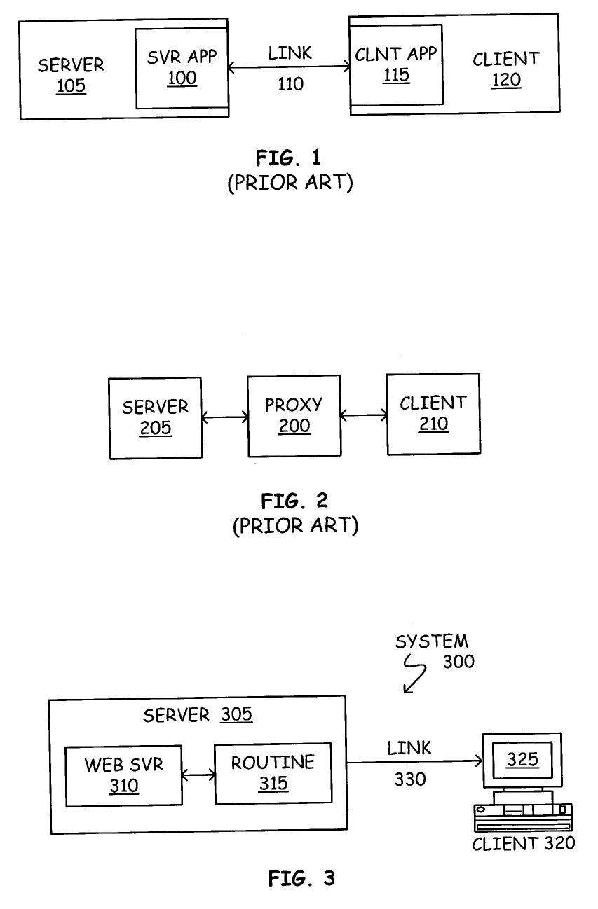

### DETAILED DESCRIPTION

The invention relates generally to data compression and more particularly to server-side only techniques for the selective compression of data based on user-specified controls in an web-based operating environment. As used herein, the phrase “server-side only” refers to techniques that rely on the execution of routines on a server computer system and, in particular, do not rely on or require the installation and operation of special purpose software or hardware on a client computer system specifically designed to operate with those routines.

Referring to FIG. 3, system 300 in accordance with one embodiment of the invention comprises server computer system 305 on which web server application 310 and selective compression routine 315 execute. As shown, routine 315 is logically positioned between web server application 310 and client computer system 320 executing conventional web browser application 325. Accordingly, data requests from browser 325 are received and passed to web server 310 by routine 315. Similarly, data returned by web server 310 in response to such requests are first received by routine 315 before being sent to browser 325 (with or without modification as described herein). It will be recognized that communication link 330 may be a dedicated point-to-point connection, a local or wide area network such as an intranet or the Internet and that any of these “communication links” may employ wired or wireless technology. While the following descriptions of routine 315 assume client-server communications via the HyperText Transport Protocol (HTTP), such descriptions are illustrative only and are not to be considered limiting in any respect.

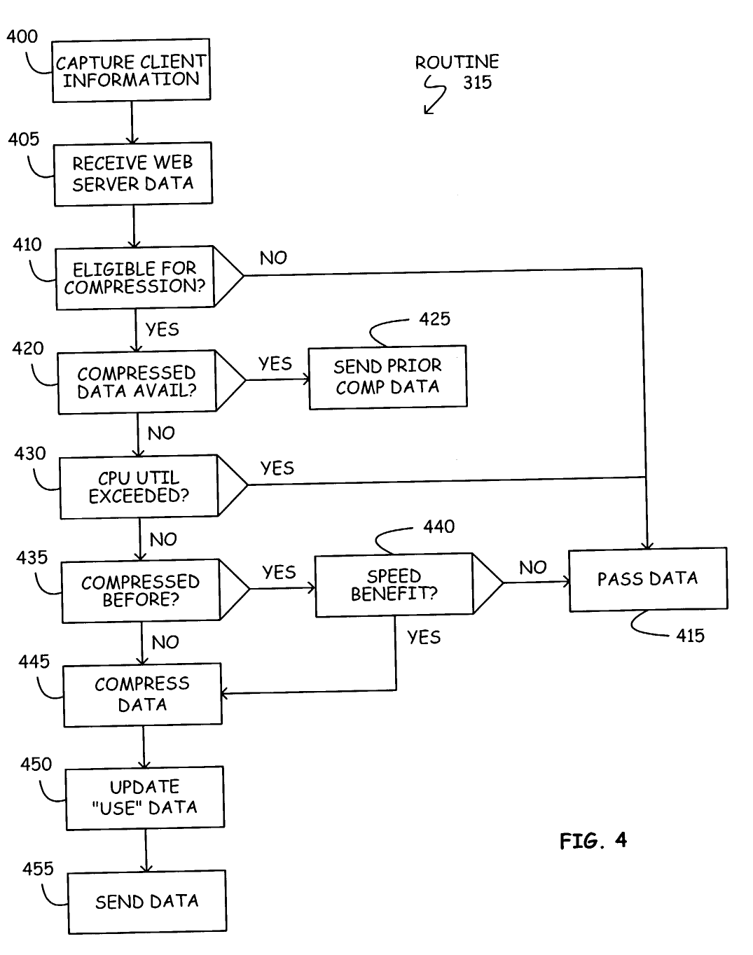

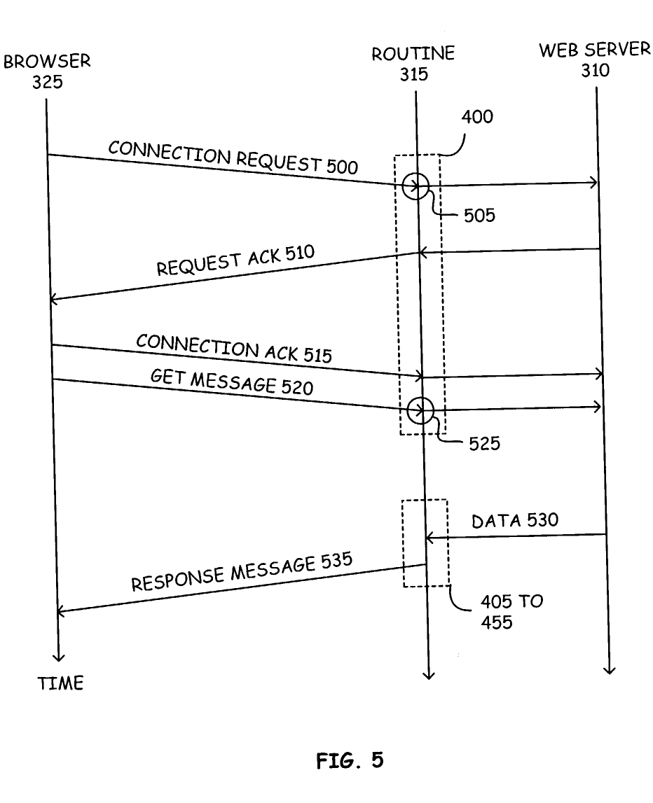

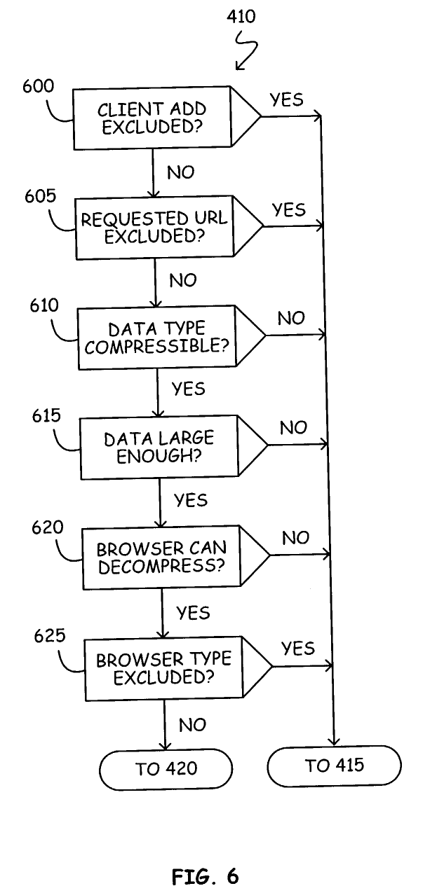

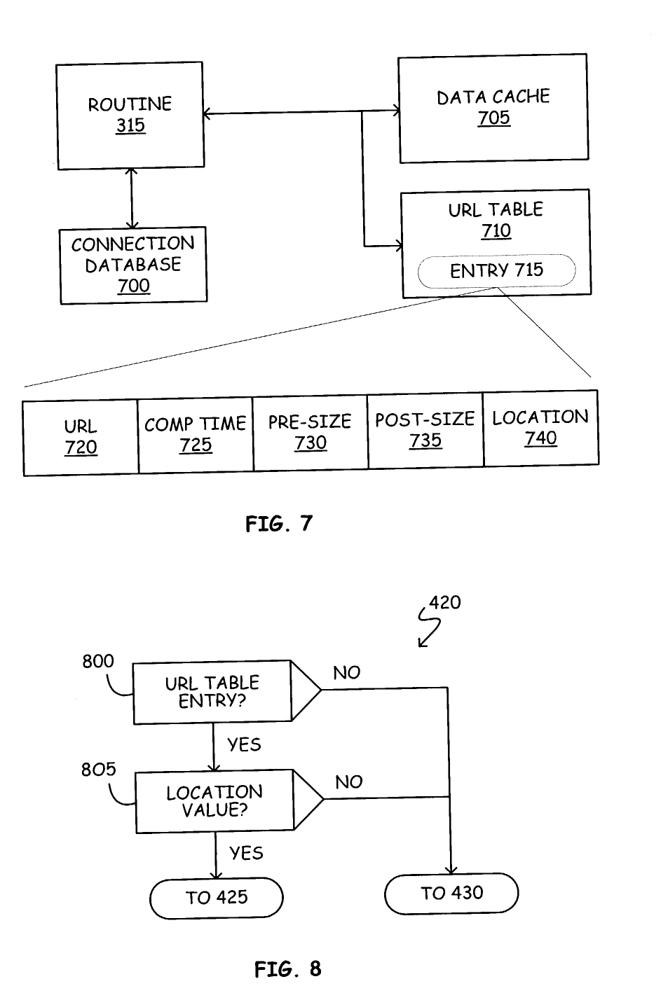

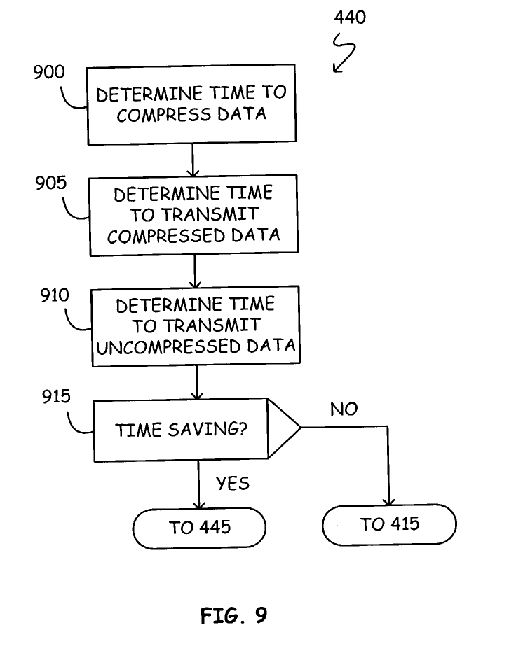

Referring to FIG. 4, routine 315 in accordance with one embodiment of the invention begins by determining certain client 320/browser 325 information (block 400). (See discussion below regarding FIG. 5.) For example, routine 315 may determine the approximate data transfer rate between browser 325 and web server 310 during connection set-up operations. In addition, routine 315 may ascertain if browser 325 supports decompression utilities. When routine 315 receives web server 310's response to browser 325's request for data (block 405), it determines whether the data contained therein is eligible for compression (decision block 410). (See discussion below regarding FIG. 6.) By way of example, data less than a specified size, or data already in a compressed format, or of a specified file type, or requested from one or more specified locations (e.g., URL patterns, see discussion below), or directed to one or more specified Internet addresses or data requested by a specified browser application (e.g., the Netscape browser of a specified version) may be designated “not eligible.” If the data is not eligible for compression (the “NO” prong of decision block 410), the data received from web server 310 during the acts of block 405 is passed or relayed to browser 325 without further processing (block 415). If the data is eligible for compression (the “YES” prong of decision block 410), routine 315 next determines if it has previously compressed the data and, if so, if the compressed data is available for transmission to browser 325 (decision block 420). (See discussion below regarding FIG. 7.) In one embodiment, routine 315 retains knowledge about, for example, whether it has previously compressed a specified data object, and, if so, the amount of compression achieved, the amount of time it took to perform the compression and whether that compressed data object is currently available for transmission to browser 325. If previously compressed data is available (the “YES” prong of decision block 420), the compressed data is sent to browser 325 (block 425). In one embodiment, if previously compressed data is not available (the “NO” prong of decision block 420), a further check is made to determine if the central processor unit executing routine 315 and/or designated to compress data for routine 315 is below a specified utilization (decision block 430). The check of block 430 may be performed to ensure that server 305 (or a functional unit associated with server 305) is not tasked to perform a computationally intensive job (the act of compressing data) if it is already heavily utilized for other tasks. For example, a utilization threshold may be set at a specified percentage of the processor's total capacity. In some embodiments, this threshold may be set at the user's discretion anywhere from 0% to 100%. For example 85%. If routine 315's processor's utilization is at or above the specified threshold (the “YES” prong of decision block 430), data received from web server 310 during the acts of block 405 is passed or relayed to browser 325 without further processing (block 415). If routine 315's processor's utilization is below the specified threshold (the “NO” prong of decision block 430), routine 315 determines if it has previously compressed the data (decision block 435). (See discussion below regarding FIGS. 7 and 8.) If routine 315 has previously compressed the data and that compressed data is currently not available (the “YES” prong of decision block 435), it then determines if compressing the data would provide a transmission benefit (block 440). (See discussion below regarding FIG. 9.) For example, based on the determined transmission rate between web server 310 and browser 325 (in accordance with the acts of block 400) and the amount of time it takes to compress the data object, routine 315 can determine if the time it will take to compress the data object provides an acceptable speed-up in transmission (decision block 440). In one embodiment, if the time saved in transmitting the compressed data does not save more time (at the determined transmission rate between web server 310 and browser 325) than it takes to compress the data (the “NO” prong of decision block 440), the data received from web server 310 during the acts of block 405 is passed or relayed to browser 325 without further processing (block 415). In another embodiment, if the time saved in transmitting the compressed data does not save at least a specified amount of time, above the time it takes to compress the data (e.g., 110%), the data received from web server 310 during the acts of block 405 is passed or relayed to browser 325 without further processing (block 415). If routine 315 determines that the time saved in transmitting the compressed data is acceptable/beneficial (the “YES” prong of decision block 440) or if the data received from web server 310 has not yet been compressed (the “NO” prong of decision block 435), routine 315 compresses the data (block 445). While routine 315 may use any compression routine/technique, for historical reasons most current browsers (e.g., browser 325) incorporate the ability to decompress data in gzip format. After compressing the data, routine 315 may update a metadata store it uses to track what data objects its has compressed (block 450) and then transmit the compressed data to browser 325 (block 455). (See discussion below regarding FIGS. 7 and 8.)

FIG. 5 illustrates how one embodiment of routine 315 begins the capture of client information (see block 400 in FIG. 4) during establishment of an HTTP connection between browser 325 and web server 310. As shown, HTTP connection setup is initiated when browser 325 transmits Connection Request message 500 to web server 310 via routine 315. On receipt of Connection Request 500, routine 315 initiates a timer (505). Web server 310 responds to Connection Request message 500 by issuing Request Acknowledgement message 510. Browser 325, in turn, responds by issuing Connection Acknowledgement message 515. At this point, an HTTP connection between browser 325 and web server 310 is established. Substantially immediately after issuing Connection Acknowledgement message 515, browser 325 issues Get message 520 to initiate transfer of the data for which the connection was established. On receipt of Get message 520, routine 315 stops the timer (525). The interval measured by the timer approximates the roundtrip time between browser 325 and web server 310 and may be used to determine a transfer rate (i.e., bytes/second) because routine 315 also has knowledge of the size of each of Connection Request 500, Request Acknowledgement 510, Connection Acknowledgement 515 and Get 520 messages. One of ordinary skill in the art will recognize that the transmission rate between browser 325 and web server 310 could more accurately be determined by stopping the timer on receipt of Connection Acknowledgement message 515. In practice, however, it has been found that the time difference between receiving browser 325's Connection Acknowledgement 515 and Get 520 messages is so small that it does not significantly affect the determination of the transmission rate. In addition to determining the transfer rate between browser 325 and web server 310, routine 315 may also capture certain additional client 320/browser 325 information (525). For example, the Internet (IP) address associated with client 320 may be captured at the time Connection Request message 500 is received. In addition, HTTP Get message 520 can be used to identify: (1) the data being sought in terms of its URL; (2) the highest HTTP level supported by browser 325; (3) browser 325 type; (4) what file types browser 325 can accommodate; (5) whether browser 325 supports decompression via, for example, gzip or tar utilities; and (6) other capabilities such as, for example, platform configuration and software version information.

FIG. 6 illustrates how one embodiment of routine 315 determines if data 530 (see FIG. 5) received from web server 310 is eligible for compression (see block 410 in FIG. 4). As shown, an initial check is made to determine if the IP address associated with client 320 has been excluded by the user (decision block 600). For example, the user may not want to compress any data transmitted to IP address AAA.1.1.1 or the block of IP addresses identified by 1B.*.*.* (i.e., all IP addresses beginning with 1B). If client 320's IP address has been excluded or restricted as described above (the “YES” prong of decision block 600), control passes to block 415 in FIG. 4. If client 320's IP address has not been excluded or is unrestricted (the “NO” prong of decision block 600), a second check is made to determine if data 530 is from a specified one or more locations (decision block 605). That is, the invention allows the user to identify one or more restricted URLs. For example, a user may not want to compress data requested from the location identified by the URL http://www.bmc.com/abc or from any destinations identified via the URL pattern http://www.bmc.com/* (meaning any destination at the bmc.com web site). If data 530's URL has been excluded or restricted as described above (the “YES” prong of decision block 605), control passes to block 415 in FIG. 4. If data 530's URL has not been excluded (the “NO” prong of decision block 605), a third check is made to determine if data 530 is compressible (decision block 610). For example, image files such as Graphic Image Format (GIF) and Joint Photographic Experts Group (JPEG) files are not typically compressible and are, therefore, not generally processed further. In addition, archive files such as “zip” and “tar” files are already in compressed form and are, therefore, not generally processed further. Further, a user may specify that certain file types (e.g., Portable Document Format, PDF, files) are not to be compressed. If data 530 is not compressible (the “NO” prong of decision block 610), control passes to block 415 in FIG. 4. If data 530 in compressible (the “YES” prong of decision block 610), a fourth check is made to determine if data 530 is at least a minimum size (decision block 615). This test is performed to avoid compressing files that are so small that the computational overhead of compressing them exceeds the time savings obtained in their transmission. An illustrative “minimum size” is 200 bytes. If the size of data 530 is less than or equal to a minimum specified size (the “NO” prong of decision block 615), control passes to block 415 in FIG. 4. If data 530 in larger than the minimum specified size (the “YES” prong of decision block 615), a fifth check is made to determine if browser 325 is capable of handling compressed data (decision block 620). If browser 325 cannot handle compressed data (the “NO” prong of decision block 620), control passes to block 415 in FIG. 4. If browser 325 can handle compressed data (the “YES” prong of decision block 620), a sixth check is made to determine if the user has restricted compressed transmission to the specific type of browser making the request (decision block 625). For example, a user may specify that compressed data is not to be sent to version 6 of browsers provided by the Netscape Corporation. If browser 325 is a type (i.e., has a “signature”) that has been excluded by the user (the “YES” prong of decision block 625), control passes to block 415 in FIG. 4. If browser 325 is of a type not excluded by the user (the “NO” prong of decision block 625), control passes to decision block 420 in FIG. 4. One of ordinary skill in the art will recognize that one or more additional tests may also be implemented or that fewer than the described tests can be performed or that the tests may be run in various orders. For example, if certain browser types are known to be unable to handle certain data in compressed form (even if they can handle compressed data in general), a test may be performed for this/these conditions.

Referring now to FIG. 7, in one embodiment of the invention routine 315 maintains, and has access to, three (3) storage areas: connection database 700, data cache 705 and URL table 710 (see, for example, the discussion above regarding FIG. 4 at blocks 420 and 435-450). Connection database 700 is used by routine 315 to track each user request for data (i.e., an HTTP connection in accordance with 500, 510, 515 and 520 of FIG. 5). For example, unique identifiers may be assigned to each requesting agent (e.g., browser 325 in FIG. 3). In addition, this storage is where routine 315 typically records the transmission rate determined in accordance with block 400 in FIG. 4 and discussed above regarding FIG. 5. Data cache 705 is used by routine 315 to store data received from web server 310 that has been compressed. URL table 710 is used to store metadata associated with each compressed data object and, in one embodiment, is organized in accordance with the data object's URL value. In the embodiment of FIG. 7, each URL table entry 715 identifies a data object's URL 720, the time it took to compress the data object 725, the data object's size before compression 730, the data object's size after compression 735 and the location of the compressed data object 740 in data cache 705. In one embodiment, each data object that has been compressed is stored in data cache 705 and each compressed object has an entry in URL table 710. In another embodiment, data cache 705 may be smaller than needed to store all compressed data objects and/or URL table 710 may be smaller than needed to store all of the compressed data object's metadata entries. In the latter case, it may be necessary to periodically remove some entries from data cache 705 and/or URL table 710 to make room for a new entry. Techniques to do this are known in the art as cache management techniques. One of ordinary skill in the art will recognize that a consequence of limited storage can be that URL table 710 may contain an entry for a data object that has been removed (flushed) from data cache 705. Accordingly, when a data object is removed from data cache 705, its entry in URL table 710 is either removed or, in a preferred embodiment, modified to note this. For example, the “removed” object's URL table's entry may have its location field 740 set to a value indicating that the object no longer is available. In this latter embodiment, URL table entries corresponding to data objects that have been removed from data cache 705, may be beneficial during the acts of blocks 420, 435 and 440 of FIG. 4.

In one embodiment of the invention, routine 315 makes use of the storage structures of FIG. 7 to determine if a compressed data object is available for transmission (block 420 in FIG. 4), whether the data object being processed has been previously compressed (block 435 in FIG. 4) and whether compressing the data object will provide a benefit (block 440 in FIG. 4). Referring to FIG. 8, the acts of block 420 to determine if a compressed data object is available comprise determining if the data object has a URL table entry (decision block 800). If the data object does not have a URL table entry (the “NO” prong of decision block 800), either the data object has never been compressed before or, if it has, both its data cache and URL table entries have been purged (see discussion above). In either case, control is passed to block 430 in FIG. 4. If the data object has a URL table entry (the “YES” prong of decision block 800), a check is made to determine if the URL table entry has an associated data cache entry (decision block 805). If the data object's URL table entry (i.e., its location field 740) does not identify a compressed object in data cache 705 (the “NO” prong of decision block 805), control is passed to block 430 in FIG. 4. If, on the other hand, the data object's URL table identifies an entry in data cache 705 (the “YES” prong of decision block 805), control passes to block 425 in FIG. 4. Similarly, the acts of block 435 to determine if the data object being processed has been previously compressed, routine 315 determines if the data object has a URL table entry. Referring now to FIG. 9, the acts of block 440 to determine if there would be a speed benefit to compressing the current data objects comprise determining the time it would take to compress the data object (block 900). For example, the data object's URL table entry's compression time field 725 provides this information. Next, the time needed to transmit the compressed data object based on the transmission rate calculated in accordance with block 400 of FIG. 4 and recorded in connection database 700 is determined (block 905). A similar calculation is performed to determine the time needed to transmit the uncompressed data object (block 910). If the calculated time savings meets or exceeds a specified level as discussed above (the “YES” prong of decision block 915), control is passed to block 445 in FIG. 4. If the calculated time savings does not meet the specified level (the “NO” prong of decision block 915), control is passed to block 415 in FIG. 4. It is noted, that the acts of block 440 (and FIG. 9) are only performed if the data object being processed has a corresponding URL table entry but no data cache entry.

In some embodiments, if the data being transmitted from web server 310 to browser 325 (e.g., data 530 of FIG. 5) was dynamically generated, it is not stored in data cache 705 and an entry for the data object is not stored in URL table 710. That is, the acts of block 450 (see FIG. 4) are not performed for dynamically generated data objects. In the context of the current discussion, the phrase “dynamically generated” refers to data (e.g., data 530) whose content is uniquely generated by the responding application (e.g., web server 310) in answer to a user query (e.g., Get message 520) and which may change from query to query. For example, data 530 may comprise a dynamically generated HyperText Markup Language (HTML) web-page.

One benefit of a compression routine in accordance with the invention is that only server-side installation and execution is required. This can provide significant advantage over techniques and technologies that require and rely on the operation of companion software and/or hardware on client side computer is systems. This advantage is particularly relevant in distributed environments such as the Internet in which a provider organization (e.g., a business operating computer server 305 in FIG. 3) provides services and/or data to an unknown number of users via standard Internet messaging protocols. Another benefit of a compression routine in accordance with the invention is that only data that a user (e.g., the operator of computer server 305) determines to be beneficial is compressed. Yet another benefit of a compression routine in accordance with the invention is that characteristics other than the data itself may be considered to determine if it is beneficial or desirable to compress data. For example, the IP address of the destination computer server may be considered as can the inherent capabilities of the receiving application (e.g., a web browser). It has been found that selective compression in accordance with the techniques described herein, provide a twenty percent (20%) to fifty percent (50%) improvement in transmission speed to client applications in a web-based environment.

Various changes in the materials, components, circuit elements, as well as in the details of the illustrated operational methods are possible without departing from the scope of the claims. For instance, computer server 305 in FIG. 3 may be a mainframe computer system, a high-performance workstation computer system, a personal computer system or a specially designed device to interact with web-based communications (e.g., via link 330). Furthermore, any of these embodiments may execute any desired operating system. In addition, acts in accordance with FIGS. 4, 5, 6, 8 and 9 may be performed by a programmable control device executing instructions organized into a program module (e.g., routine 315). A programmable control device may be a single computer processor, a plurality of computer processors coupled by a communications link, or a custom designed state machine. Custom designed state machines may be embodied in a hardware device such as a printed circuit board comprising discrete logic, integrated circuits, or specially designed application specific integrated circuits (ASICs). Storage devices suitable for tangibly embodying program instructions include all forms of non-volatile memory including, but not limited to: semiconductor memory devices such as electrically programmable read only memory (EPROM), electrically erasable programmable read only memory (EEPROM), and flash devices; magnetic disks (fixed, floppy, and removable); other magnetic media such as tape; and optical media such as CD-ROM disks. Similarly, one of ordinary skill in the art will recognize that connection database 700, data cache 705 and URL table 710 (see FIG. 7) may be embodied in one or more physical storage devices such as, for example, dynamic and static random access memory (DRAM and SRAM) devices. It will further be recognized that the size of each of connection database 700, data cache 705 and URL table 710 is an implementation detail, but that the sizes chosen will impact the number of entries that may be retained in each and, as a consequence, the need or desirability of various memory management techniques.

While the invention has been disclosed with respect to a limited number of embodiments, numerous modifications and variations will be appreciated by those skilled in the art. It is intended, therefore, that the following claims cover all such modifications and variations that may fall within the true sprit and scope of the invention.

What is claimed is:

1. A method executing on a server computer to selectively compress data, comprising:
receiving a request for data from a web-based application executing on a client computer, the client being different from the server;
determining a plurality of characteristics associated with the client;
passing the request to an application executing on the server;
receiving a response from the server, the response having a data component, the data component having attributes;
selectively compressing the data component based on a match between at least one of the client characteristics and at least one of the data component attributes; and
transmitting the selectively compressed data component to the client.

2. The method of claim 1, wherein the act of receiving a request for data, comprises receiving a request for data from an application using a web-based communication protocol.

3. The method of claim 2, wherein the web-based communication protocol comprises a HyperText Transport Protocol (HTTP).

4. The method of claim 3, wherein the act of receiving a request in the HyperText Transport Protocol comprises receiving a request for data from a web-browser application executing on the client.

5. The method of claim 3, wherein the act of receiving a request for data comprises receiving a request for data from an application-server application.

6. The method of claim 1, wherein the act of determining a plurality of characteristics associated with the web-based application comprises determining an Internet address associated with the client, a Uniform Resource Locator associated with the data and whether the web-based application can uncompress data.

7. The method of claim 1, wherein the act of passing the request to an application comprises passing the request to a web-server application.

8. The method of claim 1, wherein the act of receiving a response from the server further comprises identifying one or more data component attributes selected from the group consisting of size and data type.

9. The method of claim 1, wherein the act of selectively compressing the data component comprises, compressing the data component if an Internet address associated with the client is an unrestricted Internet address.

10. The method of claim 1, wherein the act of selectively compressing the data component comprises, compressing the data component if the data component is associated with an unrestricted Uniform Resource Locator.

11. The method of claim 1, wherein the act of selectively compressing the data component comprises, compressing the data component if a processor designated to compress the data component has a utilization factor below a specified threshold.

12. The method of claim 1, wherein the act of selectively compressing the data component comprises, compressing the data component if a size attribute of the data component indicates the data component is larger than a minimum specified size.

13. The method of claim 1, wherein the act of selectively compressing the data component comprises, compressing the data component if a client characteristic indicates the web-based application is capable of decompressing data.

14. The method of claim 1, wherein the act of transmitting the selectively compressed data component to the client comprises:
compressing the data component in accordance with a compression routine acceptable to the web-based application; and
transmitting the compressed data component to the web-based application.

15. The method of claim 14, further comprising recording compression information associated with the data component in a first storage.

16. The method of claim 15, wherein the act of recording compression information in the first storage comprises:
recording a uniform resource locator (URL) associated with the data component;
recording a value indicative of a size of the compressed data component; and
recording a value indicative of the time required to compress the data component.

17. The method of claim 16, further comprising:
storing the compressed data component in a second storage; and
recording, in the first storage, an value indicative of a location of the compressed data component in the second storage.

18. The method of claim 17, wherein the act of storing the compressed data component in the second storage comprises:
determining if the second storage has sufficient room to store the compressed data component; and
if it does not,
removing a previously stored compressed data component from the second storage,
modifying a value in the first storage indicative of the location of the previously compressed data component to indicate the previously compressed data component has been removed from the second storage, and
storing the compressed data component in the second storage.

19. The method of claim 1, wherein the act of determining a plurality of characteristics associated with the client comprises determining a transmission rate between the server and client.

20. The method of claim 19, wherein the act of selectively compressing the data component comprises determining whether the data component has been previously compressed and, if it has:
determining a first time indicative of the time required to compress the data component;
determining a second time indicative of the time required transmit the compressed data component;
determining a third time indicative of the time required to transmit the data component; and
compressing the data component if the sum of the first time and the second time is less than the third time by at least a specified amount.

21. The method of claim 20, wherein the specified amount is zero (0).

22. The method of claim 20, wherein the specified amount is greater than zero.

23. The method of claim 1, wherein the act of selectively compressing the data component and transmitting the selectively compressed data component to the client comprises, determining whether the data component has been previously compressed and, if it has, whether it is available and, if it is, then transmitting the previously compressed data component to the client.

24. A program storage device, readable by a programmable control device, comprising instructions stored on the program storage device for causing a server computer to:
receive a request for data from a web-based application executing on a client computer, the client computer being different from the server computer;
determine a plurality of characteristics associated with the client;
pass the request to an application executing on the server;
receive a response from the server, the response having a data component, the data component having attributes;
selectively compress the data component based on a match between at least one of the client characteristics and at least one of the data component attributes; and
transmit the selectively compressed data component to the client.

25. The program storage device of claim 24, wherein the instructions to receive a request for data from a web-based application, comprise instructions to receive a request for data from an application using a HyperText Transport Protocol (HTTP).

26. The program storage device of claim 24, wherein the instructions to determine a plurality of characteristics associated with the web-based application comprise instructions to determine an Internet address associated with the client and a Uniform Resource Locator associated with the data.

27. The program storage device of claim 24, wherein the instructions to receive a response from the server comprise instructions to identify a size attribute of the data component.

28. The program storage device of claim 24, wherein the instructions to selectively compress the data component, comprises instructions to compress the data component if the client computer is associated with an unrestricted Internet address.

29. The program storage device of claim 24, wherein the instructions to selectively compress the data component, comprises instructions to compress the data component if the data is associated with an unrestricted Uniform Resource Locator.

30. The program storage device of claim 24, wherein the instructions to selectively compress the data component, comprises instructions to compress the data component if a processor designated to compress the data component has a utilization factor below a specified threshold.

31. The program storage device of claim 24, wherein the instructions to transmit the selectively compressed data component to the client comprise instructions to record compression information associated with the data component in a first storage.

32. The program storage device of claim 24, wherein the instructions to determine a plurality of characteristics associated with the client comprise instructions to determine a transmission rate between the server and client.

33. The program storage device of claim 24, wherein the instructions to selectively compress the data component comprise instructions to determine whether the data component has been previously compressed and, if it has:
determine a first time indicative of the time required to compress the data component;
determine a second time indicative of the time required transmit the compressed data component;
determine a third time indicative of the time required to transmit the data component; and
compress the data component if the sum of the first time and the second time is less than the third time by at least a specified amount.

34. The program storage device of claim 33, wherein the instructions to compress the data component are performed if the specified amount is zero (0).

35. The program storage device of claim 33, wherein the instructions to compress the data component are performed if the specified amount is greater than zero.

36. A method to selectively compress data, comprising:
receiving, at a server computer system, a request for data from a client computer system, the client computer system being different from the server computer system;
determining a uniform resource locator (URL) associated with the requested data and a transmission rate between the server and client computer systems;
passing the request for data to a web-server application executing on the server computer system;
receiving a response from the web-server application, the response having a data component, the data component having a size;
determining if the data component has previously been compressed and, if it has, further
determining if the compressed data component is available and, if it is, transmitting the compressed data component to the client, else,
determining a first time indicative of the time required to compress the data component, a second time indicative of the time required to transmit the compressed data component to the client, a third time indicative of the time required to transmit the data component to the client, and compressing the data component if the sum of the first time and the second time is less than the third time by at least a specified amount and transmitting the compressed data component to the client; else
selectively compressing the data component if the URL associated with the data is an unrestricted URL; and
transmitting the selectively compressed data component to the client computer system.

37. The method of claim 36, wherein the act of selectively compressing the data component further comprises compressing the data component if an Internet address associated with the client computer system is an unrestricted Internet address.

38. The method of claim 36, wherein the act of selectively compressing the data component further comprises compressing the data component if the data component has a size larger than a minimum specified value.

39. The method of claim 36, wherein the act of selectively compressing the data component further comprises compressing the data component if a processor designated to for compress the data component has a utilization factor below a specified maximum value.
